(19) United States
(12) Patent Application Publication
(10) Pub. No.: US 2026/0250049 A1
(43) Pub. Date: Aug. 27, 2026

(54) METHOD OF MANUFACTURING AND AN ARTICLE FOR A DISPOSABLE LID WITH A WINDOW

(71) Applicant: HFA, INC., Wheeling, IL (US)

(72) Inventors: Norton Sarnoff, Boca Raton, IL (US); Raj Patel, Kildeer, IL (US)

(73) Assignee: HFA, INC., Wheeling, IL (US)

(21) Appl. No.: 19/065,785

(22) Filed: Feb. 27, 2025

(51) Int. Cl. B65D 43/02; B21D 22/02

(52) U.S. Cl. CPC B65D 43/0233; B21D 22/02; B65D 2543/00277

(57) ABSTRACT

In accordance with one embodiment of the invention, there is provided a disposable aluminum lid having a lid stamped from a bendable formed aluminum. The lid being defined to include a base defining a top section and a bottom section, where the base terminates at an inside edge to form a window through the base. A skirt extending downwardly from an outside edge of the base and extending continuously around the base to form a well there-between, the skirt further having a terminal lower edge. A transparent material secured over the window on the bottom section of the base.

### CROSS REFERENCE TO OTHER APPLICATIONS

The present application is a continuation in part of the following US Design Applications: (a) Ser. No. 29/977,681 filed Dec. 10, 2024 for a Rectangular Lid with a Circular Window; (b) Ser. No. 29/977,682 filed Dec. 10, 2024 for a Rectangular Lid with a Heart Shaped Window; (c) Ser. No. 29/977,689 filed Dec. 10, 2024 for a Rectangular Lid with a Hexagon Shaped Window; (d) Ser. No. 29/977,691 filed Dec. 10, 2024 for a Rectangular Lid with a Triangular Shaped Window; (e) Ser. No. 29/977,692 filed Dec. 10, 2024 for a Rectangular Lid with a Square Shaped Window; (f) Ser. No. 29/977,693 filed Dec. 10, 2024 for a Rectangular Lid with a Diamond Shaped Window; (h) Ser. No. 29/977,701 filed Dec. 10, 2024 for a Rectangular Lid with a Star Shaped Window; (i) Ser. No. 29/977,705 filed Dec. 10, 2024 for a Rectangular Lid with a Rectangular Window; (j) Ser. No. 29/980,338 filed Dec. 24, 2024 for a Circular Lid with a Circular Shaped Window; (k) Ser. No. 29/980,340 filed Dec. 24, 2024 for a Circular Lid with a Heart Shaped Window; (I) Ser. No. 29/980,344 filed Dec. 24, 2024 for a Circular Lid with a Hexagon Shaped Window; (m) Ser. No. 29/980,345 filed Dec. 24, 2024 for a Circular Lid with a Triangular Shaped Window; (n) Ser. No. 29/980,349 filed Dec. 24, 2024 for a Circular Lid with a Square Shaped Window; (o) Ser. No. 29/980,354 filed Dec. 24, 2024 for a Circular Lid with a Diamond Shaped Window; (p) Ser. No. 29/980,355 filed Dec. 24, 2024 for a Circular Lid with a Star Shaped Window; and (q) Ser. No. 29/980,361 filed Dec. 24, 2024 for a Circular Lid with a Rectangular Shaped Window, all of which are hereby incorporated by reference.

### FIELD OF THE INVENTION

The present invention relates to the art of pan lids manufactured from aluminum or cardboard such that the lids are disposable, and more particularly, the present invention is directed to a method of manufacturing and an article for a disposable lid with transparent windows.

### BACKGROUND OF THE INVENTION

Disposable aluminum pans and their corresponding lids are often referred to as foil pans/lids widely used by consumers to cook and keep food warm. The lids have been manufactured by well know methods. When the lids are disposable aluminum, a die is used to stamp a sheet of aluminum into a lid. During the stamping process upper and lower dies are pressed together with the sheet of aluminum feed between the dies. After pressing, the lid is formed. In the case of disposable cardboard lids, typically multiple layers are secured/glued together Oftentimes, one side is a cardboard material and the other side is aluminum.

The lids are always a solid form of material that the consumer uses to completely cover the pan and the contents within the pan are kept warm. The problem is that for the user to look inside the pan, the user must remove either a portion of the lid or the entire lid. This immediately releases heat from the inside of the pan. Other lids which can be made of glass or made from a stainless steel or other material are known to exist with windows. However, there is no known (either now or in the prior art) aluminum disposable lid made from aluminum or cardboard to define a flexible/bendable pan lid with a transparent window.

### SUMMARY OF THE INVENTION

In accordance with one embodiment of the present invention, there is provided a method of manufacturing and an article for a disposable aluminum lid with a transparent window and the same for a disposable cardboard lid. Both lids are designed/configured for use with a disposable pan.

In a first embodiment there is a disposable aluminum lid. The lid is stamped from a bendable formed aluminum where the lid is configured to include a base defining a top section and a bottom section. The base terminating at an outside edge. A window is formed through the base and is positioned within the outside edge of the base. The lid further includes a skirt extending downwardly from an outside edge of the base and extending continuously around the base to form a well around the bottom section. The skirt further having a terminal lower edge. The lid further includes a transparent material secured over the window on the bottom section of the base.

In a second embodiment this is provided a disposable aluminum lid. The lid is stamped from aluminum. The lid is configured to include a base terminating around a periphery at an edge and the base has a top section and bottom section. A continuous skirt wall extends downwardly from the edge of the base to form a well around the bottom section. The continuous skirt being configured to bend. A window is formed through the base and further formed within the periphery of the base. A transparent material is secured over the window on the bottom section of the base.

In a third embodiment there is provided a method of manufacturing a disposable aluminum lid comprising the steps of: (a) placing a sheet of aluminum between a pair of die shoes; (b) stamping the pair of die shoes together to form, from the sheet of an aluminum, a disposable aluminum lid, and wherein the disposable aluminum lid is defined to include a base with a top section and a bottom section, the base terminating around a periphery at an edge and a skirt downwardly extending from the edge of the base; (c) cutting a window through the disposable aluminum lid; and (d) securing a transparent material over the window on the bottom section of the lid.

In a fourth embodiment of the invention, there is provided a disposable cardboard lid for a disposable pan. The lid includes a base having a cardboard material side and an aluminum material side secured to each other. The base has an outside terminal edge. A window is formed through the base. A transparent material is secured to one side of either the carboard material side or aluminum material side.

In a fifth embodiment of the invention, there is provided a method of forming a disposable cardboard lid for a disposable pan. The method includes the steps of (a) providing a cardboard material; (b) providing an aluminum material; (c) laminating the cardboard material to the aluminum material to form a base; (d) cutting the base to a predefined shape with an outside terminal edge; (e) cutting a window through the base; and (f) securing a transparent material to one side of either the cardboard material or the aluminum material.

In one or more of these embodiments, there may also be an adhesive secured around a boarder of the window on the bottom section to secure the transparent material to the bottom section. In addition, the window may have a profile shape from one of the following shapes: rectangle, square, circle, heart, hexagon, triangle, diamond, and star. And yet, in addition, the disposable aluminum lid has a defined shape of one of the following shapes, rectangle, square, circle, and oval.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIGS. 1A-1D are prior art perspective views of disposable aluminum lids and disposable cardboard lids;

FIG. 2 is a representation of a stamp machine used in manufacturing disposable aluminum lids;

FIG. 3 is a representation of the press stamping showing the upper and lower dies;

FIG. 4 is a representation of an aluminum roll used in manufacturing disposable aluminum lids;

FIG. 5 is a representation of the aluminum feed between the upper and lower dies of the stamping machine;

FIG. 6 is a representation of the disposable aluminum lid being stamped;

FIG. 7 is a representation of the disposable aluminum lid after being stamped in the stamp machine;

FIG. 8 is a representation of the upper die having a cutting outline to cut a window in the disposable aluminum lid;

FIG. 9 is a representation of the disposable aluminum lid with a transparent window secured thereto;

FIG. 10 is an exploded view of the disposable aluminum lid with a transparent window;

FIG. 11 is a representation of the disposable aluminum lid moving off of a conveyor belt;

FIG. 12 is a perspective top view of the disposable aluminum lid with a transparent window;

FIG. 13A is a perspective bottom view of the disposable aluminum lid with a transparent window;

FIG. 13B shows the disposable aluminum lid with a transparent window positioned on a disposable aluminum pan;

FIG. 14 is a perspective top view of the disposable cardboard lid with a transparent window;

FIG. 15A is a perspective bottom view of the disposable cardboard lid with a transparent window;

FIG. 15B illustrates a rectangular disposable cardboard lid positioned over a disposable pan;

FIG. 15C illustrates a circular disposable cardboard lid positioned over a disposable pan;

FIGS. 16A-16D are illustrated rectangular disposable lids with circular shaped windows;

FIGS. 17A-17D are illustrated rectangular disposable lids with heart shaped windows;

FIGS. 18A-18D are illustrated rectangular disposable lids with hexagonal shaped windows;

FIGS. 19A-19D are illustrated rectangular disposable lids with triangular shaped windows;

FIGS. 20A-20D are illustrated rectangular disposable lids with square shaped windows;

FIGS. 21A-21D are illustrated rectangular disposable lids with diamond shaped windows;

FIGS. 22A-22D are illustrated rectangular disposable lids with star shaped windows;

FIGS. 23A-23D are illustrated circular disposable lids with circular shaped windows;

FIGS. 24A-24D are illustrated circular disposable lids with heart shaped windows;

FIGS. 25A-25D are illustrated circular disposable lids with hexagonal shaped windows;

FIGS. 26A-26D are illustrated circular disposable lids with triangular shaped windows;

FIGS. 27A-27D are illustrated circular disposable lids with square shaped windows;

FIGS. 28A-28D are illustrated circular disposable lids with diamond shaped windows;

FIGS. 29A-29D are illustrated circular disposable lids with star shaped windows; and

FIGS. 30A-30D are illustrated circular disposable lids with rectangular shaped windows.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

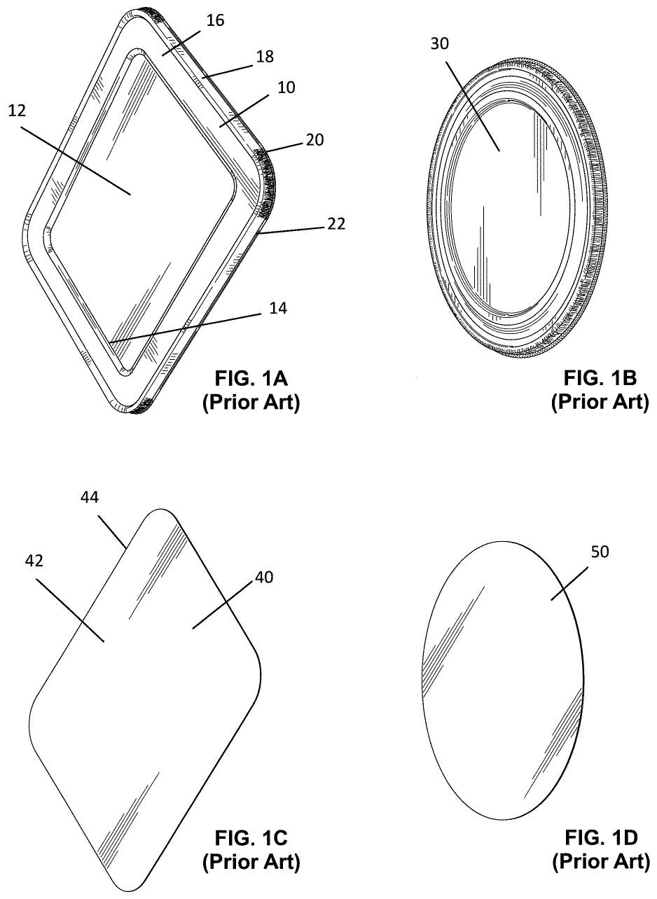

With reference to Prior Art FIGS. 1A through 1d there is provided a disposable lid formed from stamping aluminum, generally referenced as a disposable aluminum lid 10. The disposable aluminum lid 10 includes a solid top base 12 that terminates about an edge 14 to a raised ridge 16 around the periphery of the edge 14. The raised ridge 16 extends into a downwardly extending skirt 18. The skirt terminates into a rolled lip 20 formed around the entire terminal edge 22 of the skirt. The edge 22 is configured to bend around the edge of the pan. The disposable aluminum lid 10 can have various shapes, square, rectangular 10, oval, and circular 30. In another prior art lid often used for disposable aluminum pans, are cardboard lids 40. The lids also include a solid top base 42 that terminates at a periphery edge 44. The cardboard lid 40 often has one side made from a cardboard material and has a flat aluminum side. The cardboard lid 40 fits onto an aluminum pan and the edges of the pan bend and crimp around the periphery edge 44 of the cardboard lid 40. Similarly to the disposable aluminum lids, the cardboard lids can also come in various shapes, such as, but not limited to square, rectangular 40, oval, and circular 50.

The main problem with the prior art lids is the top base portions are solid material. As such, when placed on a pan and secured, the only way to see the contents is to free an edge of the lid or remove the lid entirely. This is not necessarily helpful when cooking or reheating contents, as the removal of the lid (either a section or entirely) releases heat and moisture. As such, there is a desire and necessity to have a means for seeing the contents of the pan without removing a portion of the lid or the entire lid.

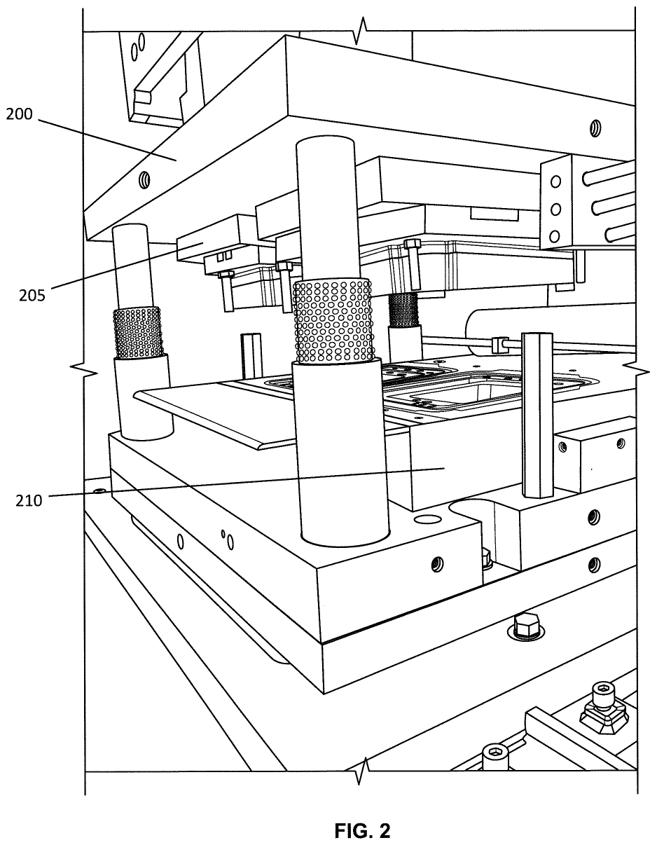

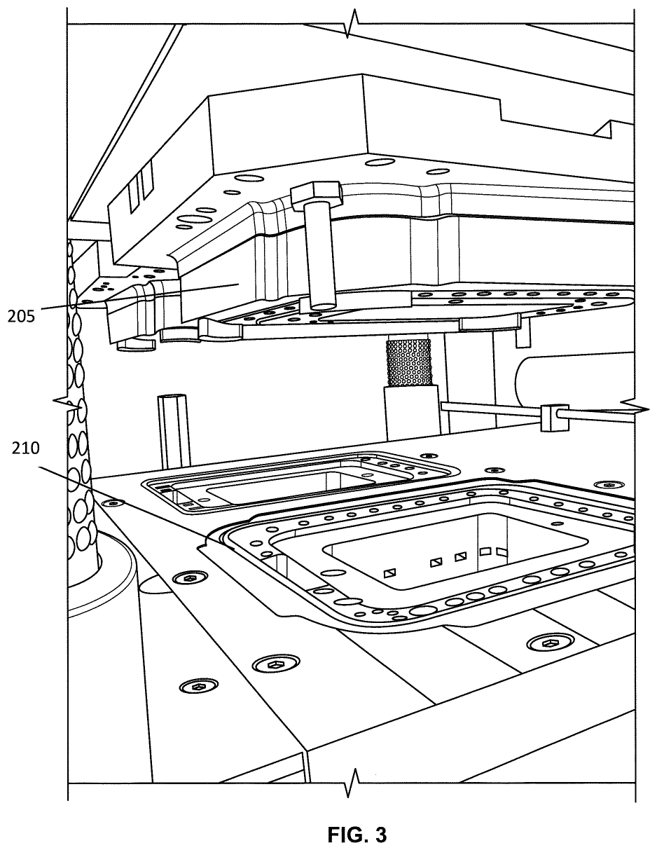

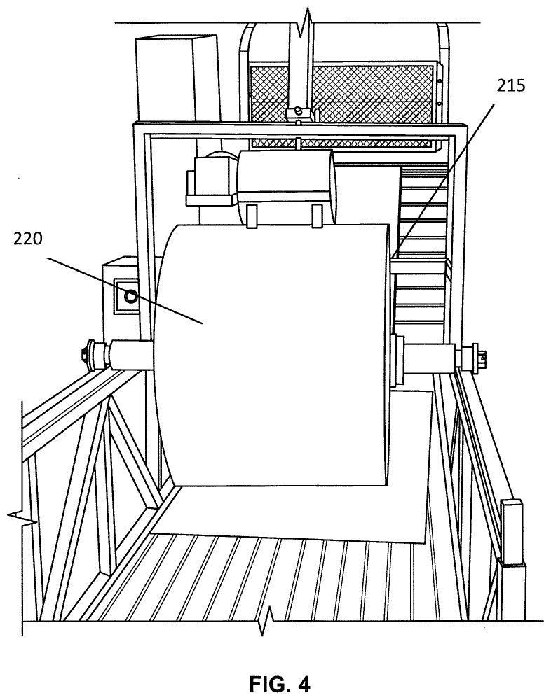

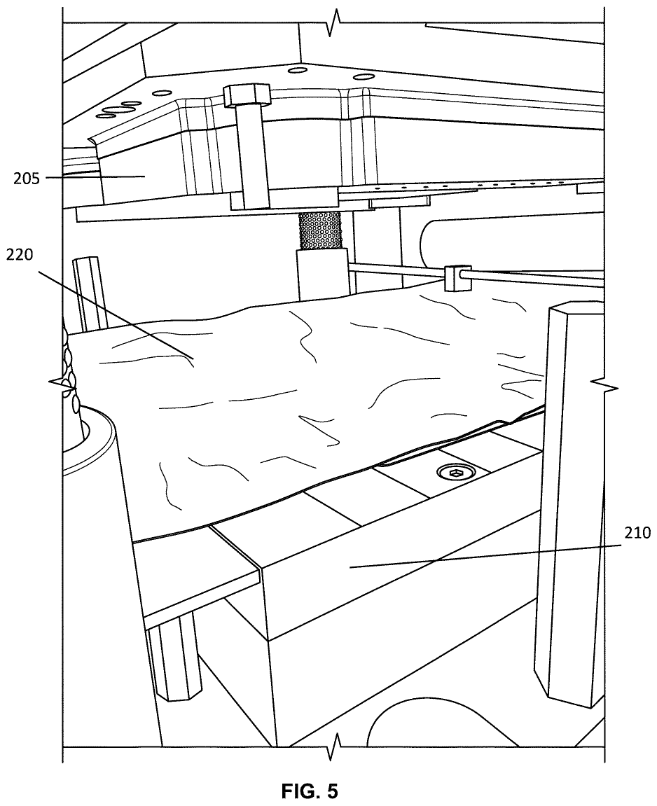

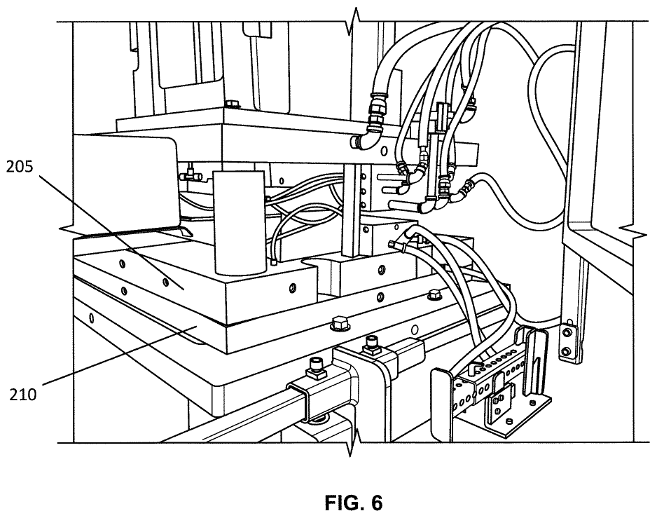

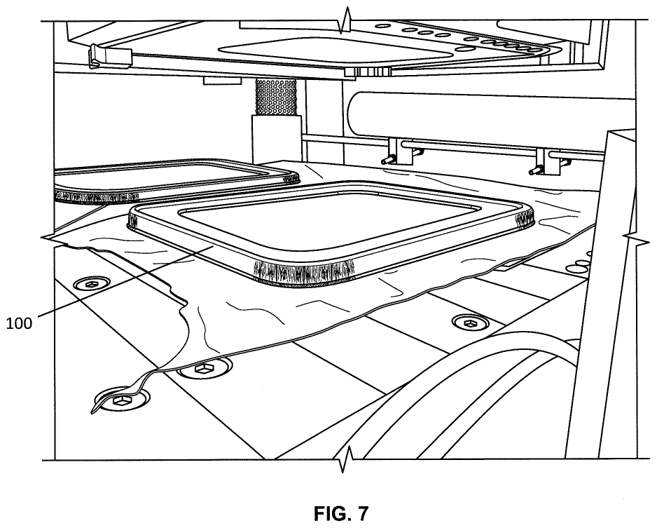

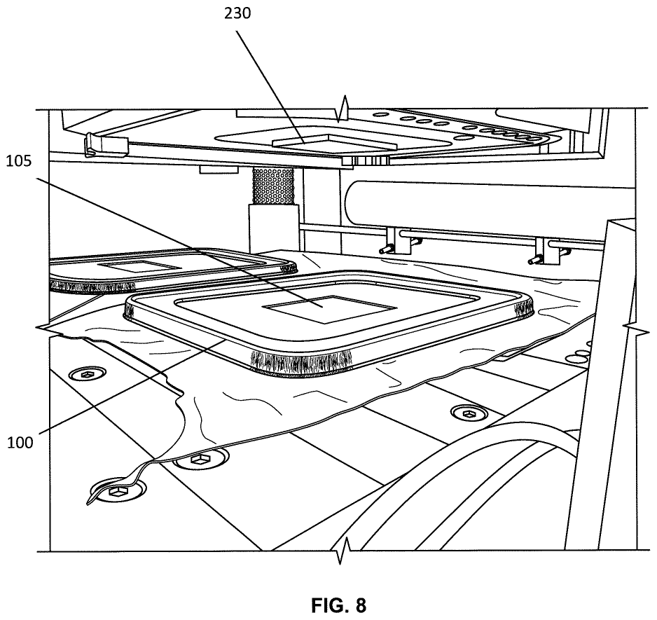

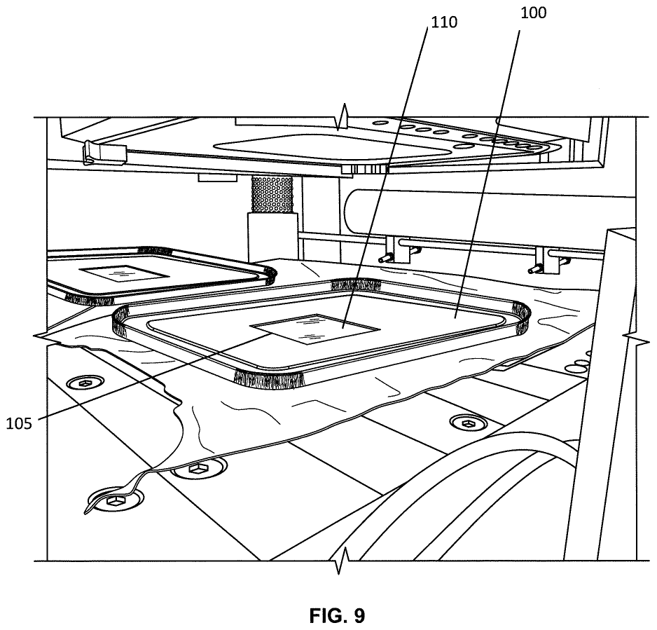

The disposable aluminum lid with a window 100 is formed from stamping aluminum. Referring now also to FIGS. 2 through 11 there is shown a method of manufacturing the disposable aluminum lids with windows 100. In the method of manufacturing, a die machine press 200 includes an upper shoe 205 and a lower shoe 210. A sheet of aluminum 220, fed from a roll 215, is positioned between the shoes, which are then hydraulically pressed together forming the lid. The upper and lower shoes 205/210 are configured to stamp the disposable aluminum lids 100 Excess aluminum can then be recycled for future use.

The disposable aluminum lids 100 when formed are then moved into a cutting shoe 230 for cutting the window into the lid. When pressed the disposable aluminum lids 100 includes a window 105. It is also possible that the forming shoes include the cutting member such that when pressed from the aluminum sheet the lid is automatically formed with the window.

The disposable aluminum lids 100 are then pressed with a transparent material 110 over the window 105. The transparent material 110 can be shaped similar to the shape of the window except slightly larger such that a boarder portion of the transparent material overlaps a boarder section 115 of the window 105. An adhesive 120, resin, or tape is positioned on the boarder portion of the lid prior to the transparent material 110 being pressed and secured to the aluminum lid. The disposable aluminum lids with windows 110 are then moved from the processing stage and stacked for transport.

Referring now to FIGS. 12 and 13A, when manufacturing, the disposable aluminum lids with windows 300 includes a top section 305 and bottom section 307. The top section 305 has an inside edge 310 and an outside edge 320. The inside edge 310 terminates at a window 350 cut out of the top base 305, while the outside edge 320 terminates about to a raised ridge 325 around the periphery of the outside edge 320. The raised ridge 325 extends into a downwardly extending skirt 330 that surrounds the bottom section 307 of the lid. The skirt 330 terminates into a rolled lip 335 formed around the entire terminal edge 340 of the skirt 330. The terminal edge 340 of the skirt is configured to bend around the edge of a pan. A transparent material 355 is secured over the window 350 on the bottom section 307. An adhesive, epoxy, or resin 360 is used to secure the transparent material 355 to a boarder section 365 surrounding the window 350. Since the lid is used in connection with food, it is preferred that the adhesive is a food grade adhesive, food safe epoxy or resin.

In FIG. 13B, there is shown the disposable aluminum lid 300 with a window 355 placed over a disposable pan 357.

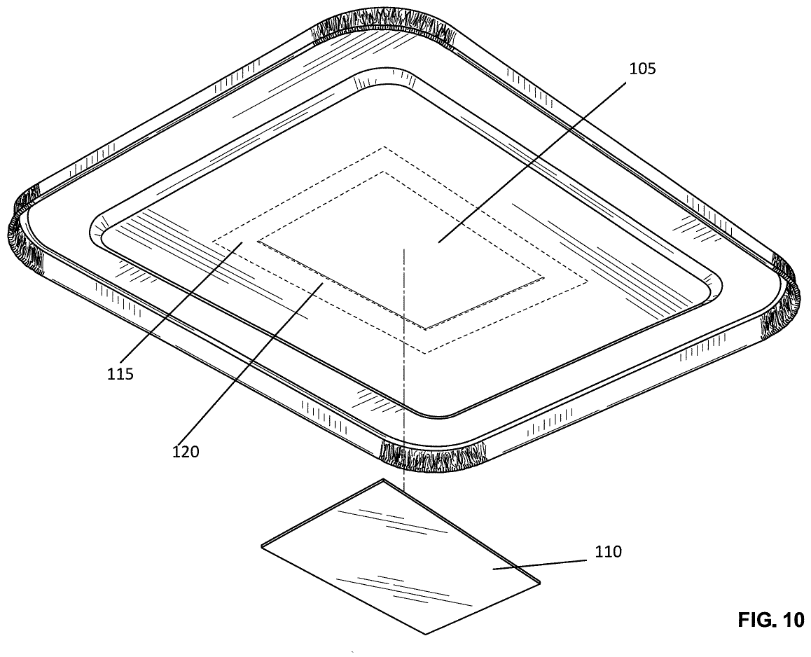

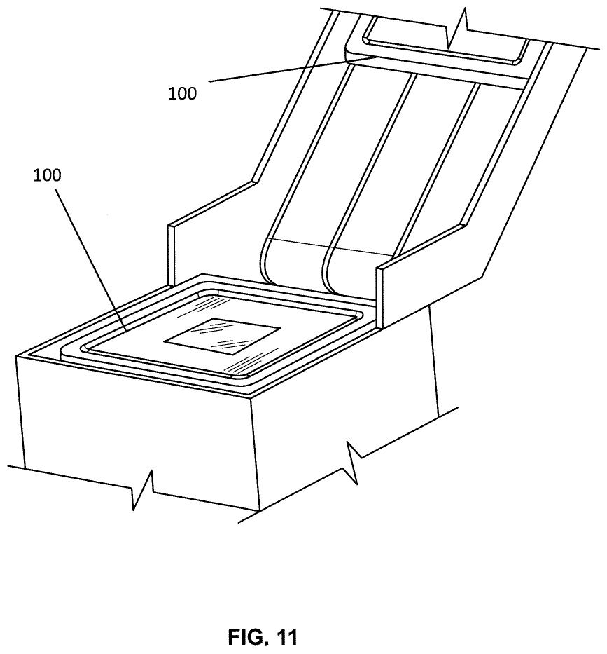

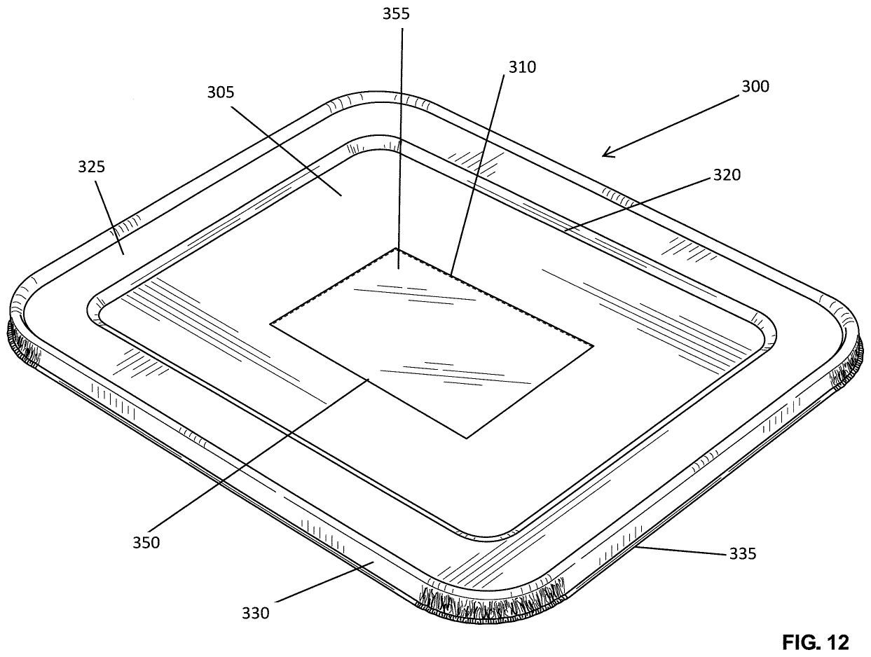

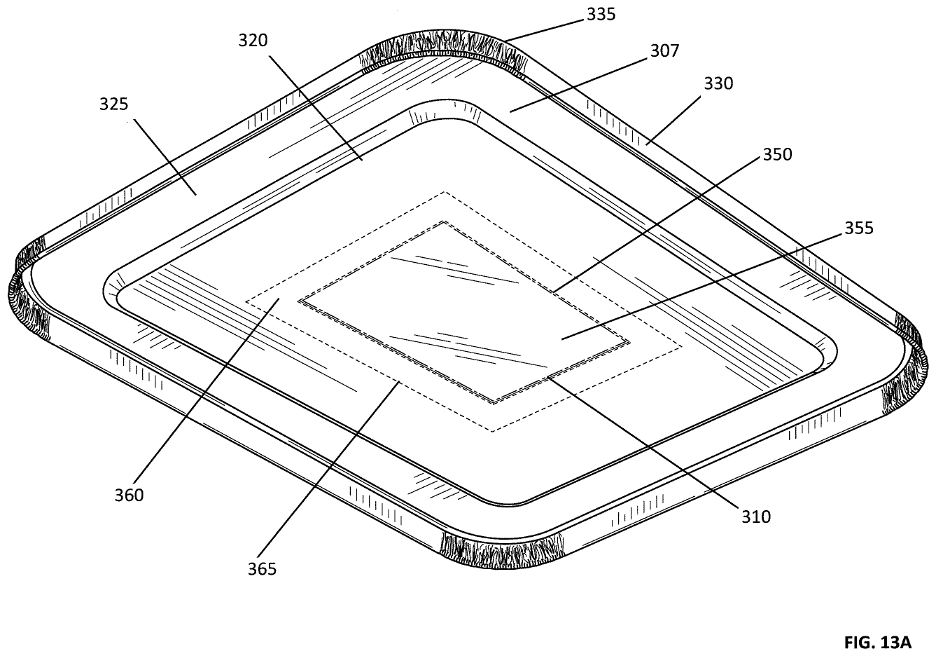

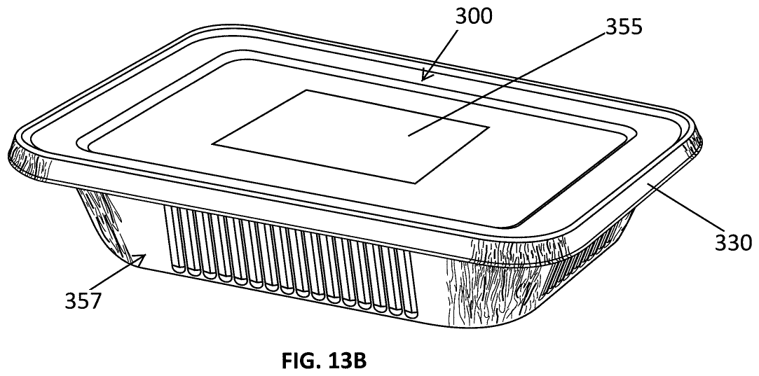

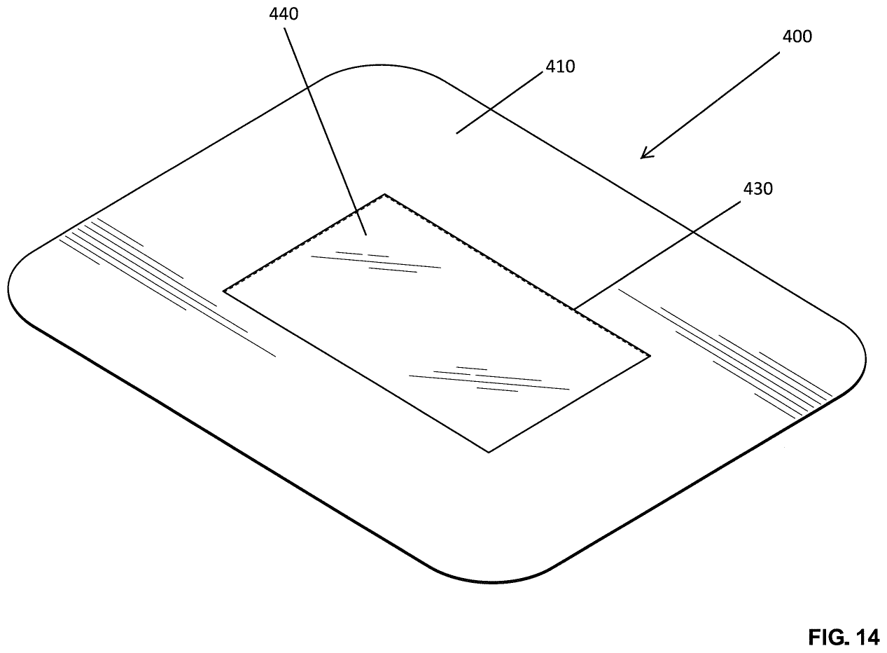

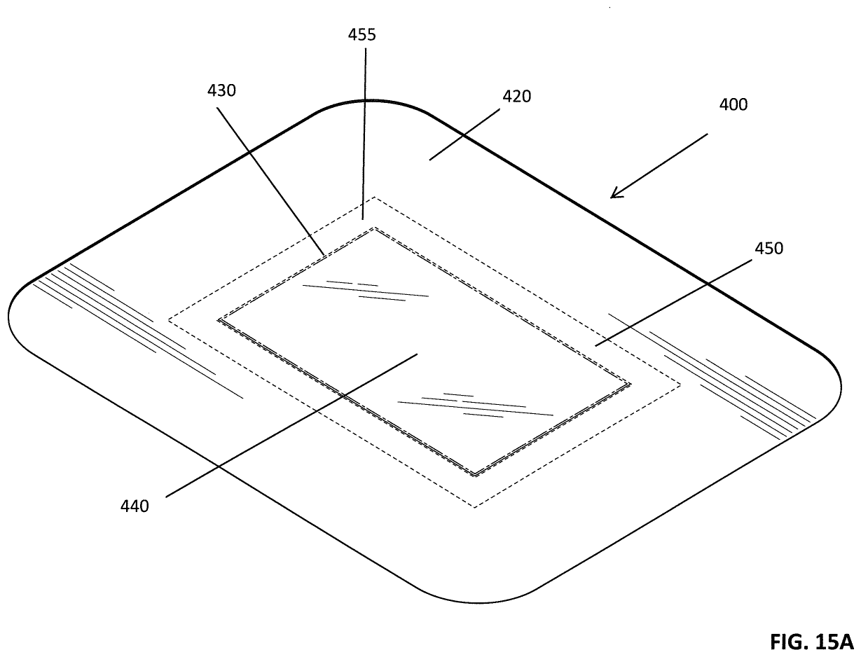

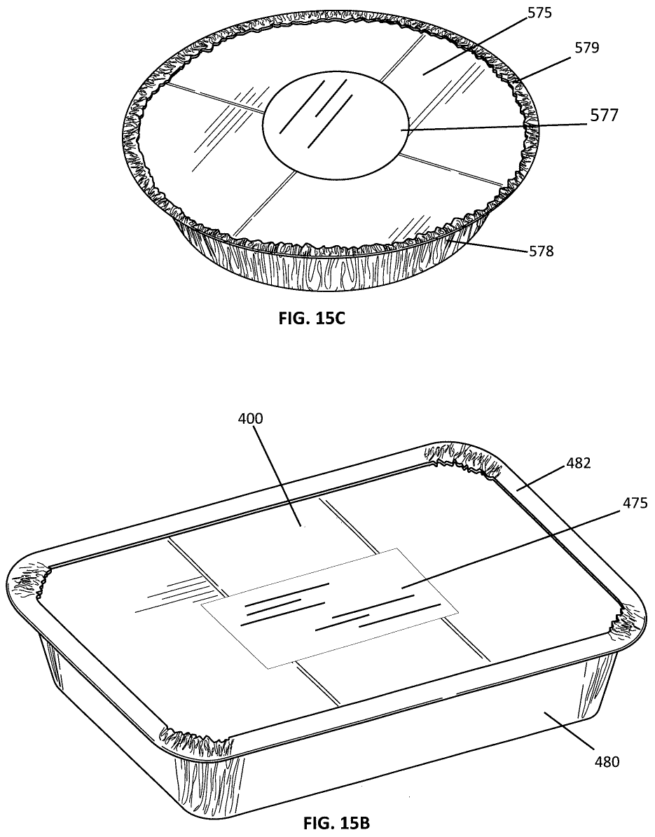

Referring now to FIGS. 14 and 15A, in a similar fashion, when the disposable lid is a cardboard lid 400, the lid 400 is fashioned by securing (by laminating and forming) a cardboard sheet to an aluminum foil, forming a carboard side 410 and aluminum foil side 420. The two side are laminated together typically by an adhesive or through heat-sealing. As noted above, the adhesive would be a food-safe adhesive capable of withstanding exposure to heat during use. Once laminated, the lid is cut to the desired size and shape.

In the present invention, after the lid is formed, the lid would then go through an additional cutting process to cut out a shaped window 430 in the lid. A transparent material 440 is then secured to the aluminum foil side 420 by an adhesive 450. The transparent material 440 would be larger than the window, such that a boarder 455 is formed around the window 430.

Referring now to FIGS. 15B and 15C, the cardboard lid 400 is then placed onto a pan 480 with the lip 482 of the pan folded over the lid 400 and the consumer able to view the contents of the pan through the transparent window 475. Similarly, the lid 575 has a transparent window 577 and is placed on pan 578 and the lip 579 folded over the terminal edge of the lid.

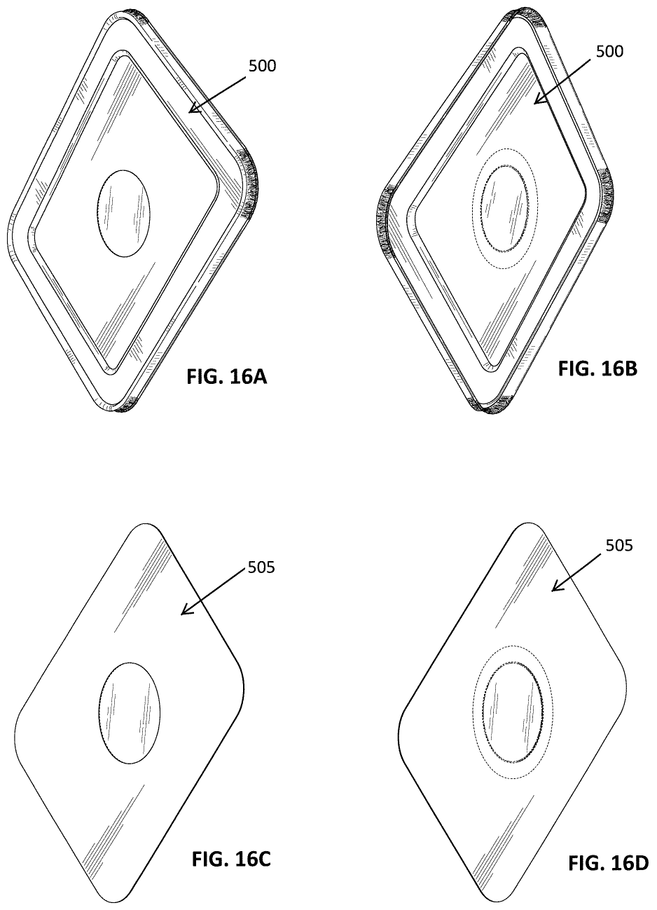

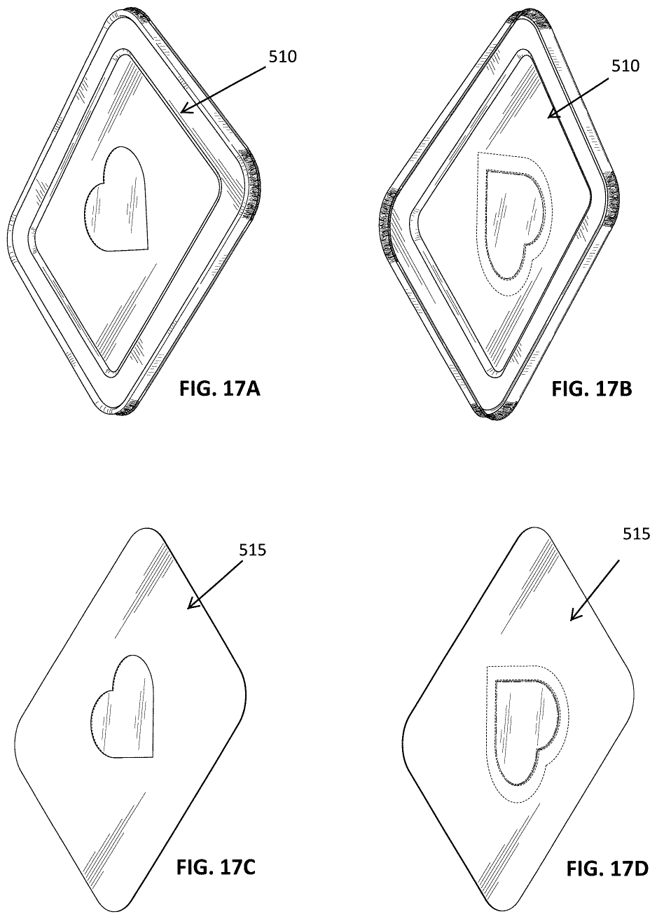

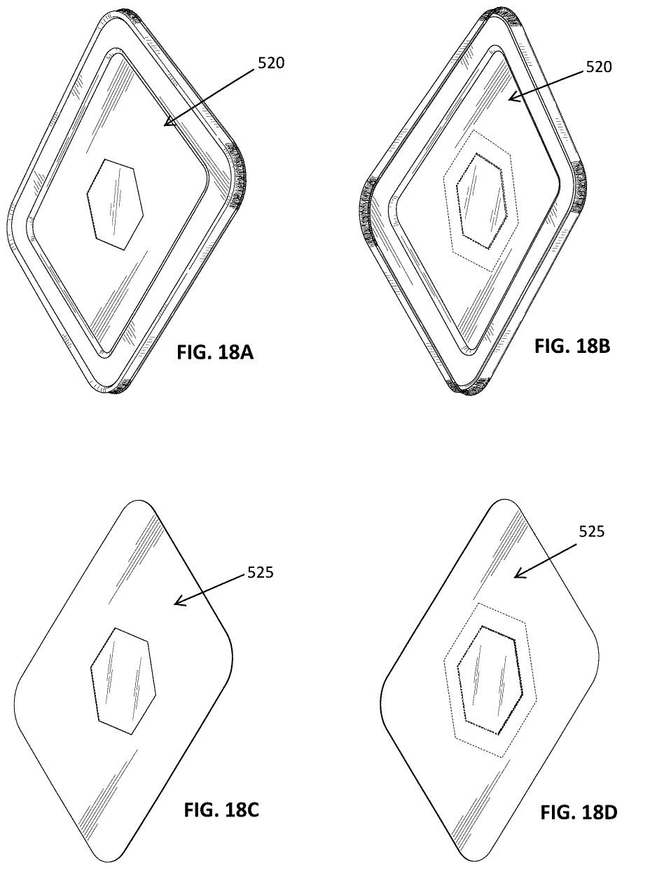

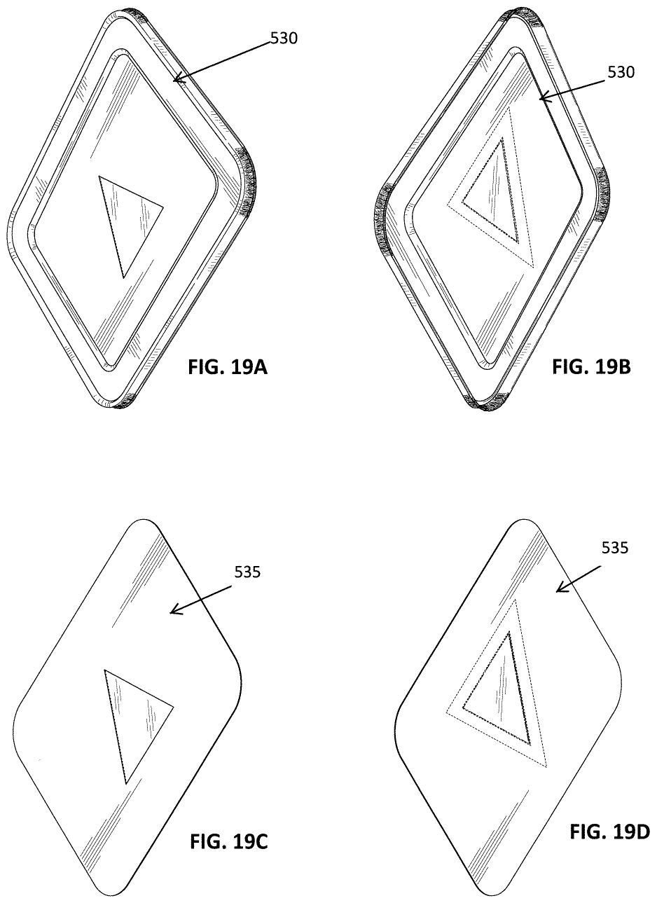

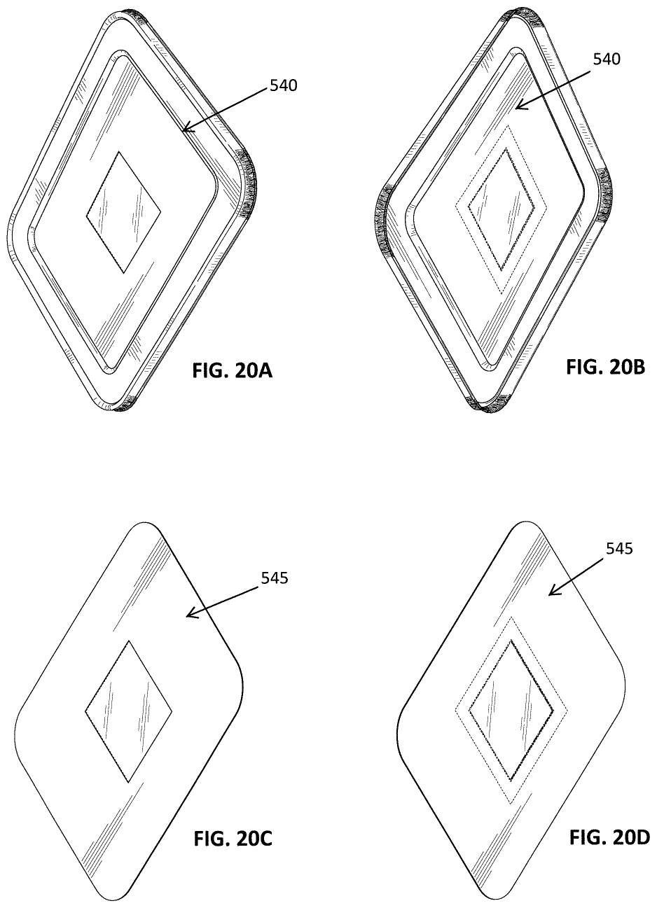

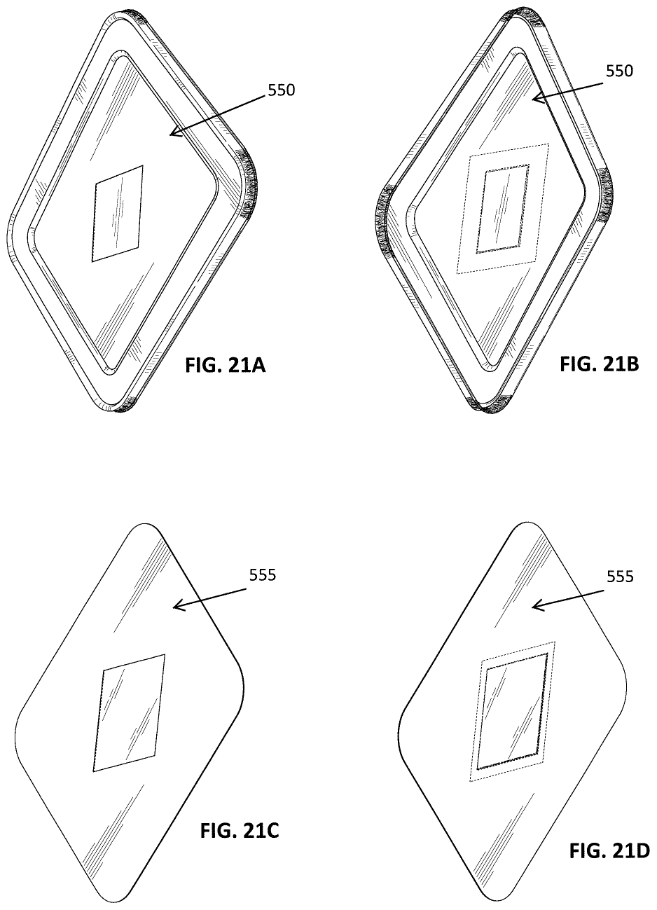

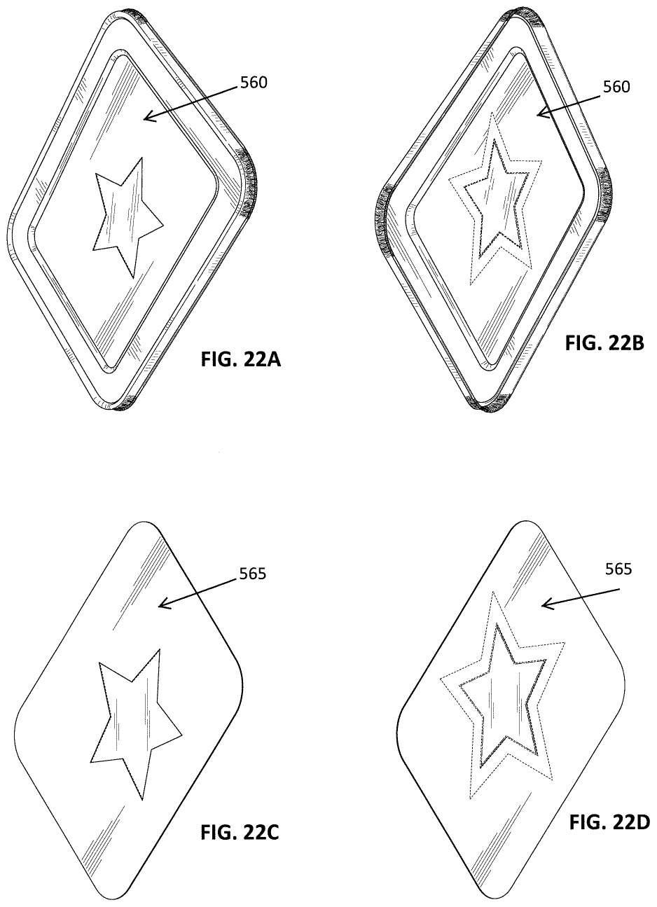

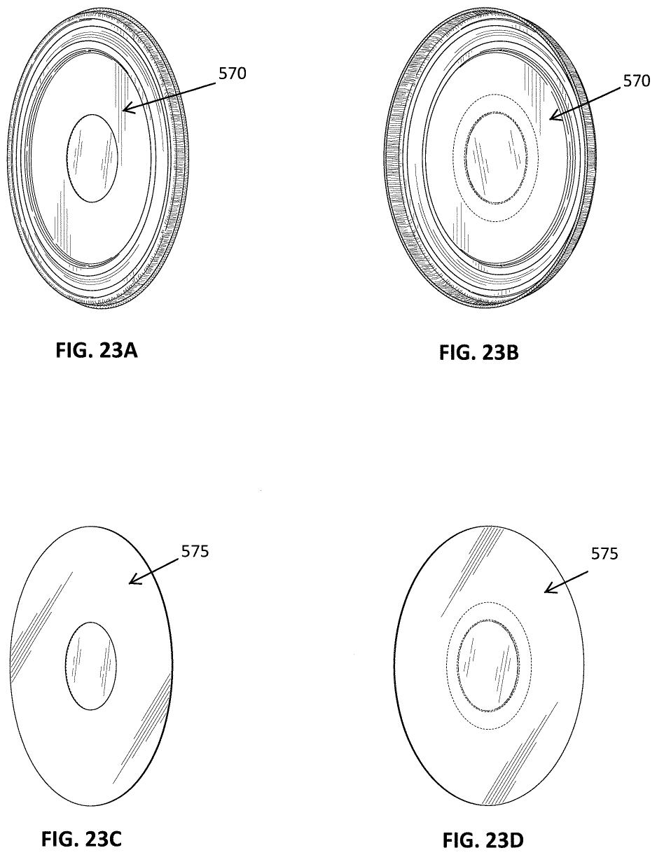

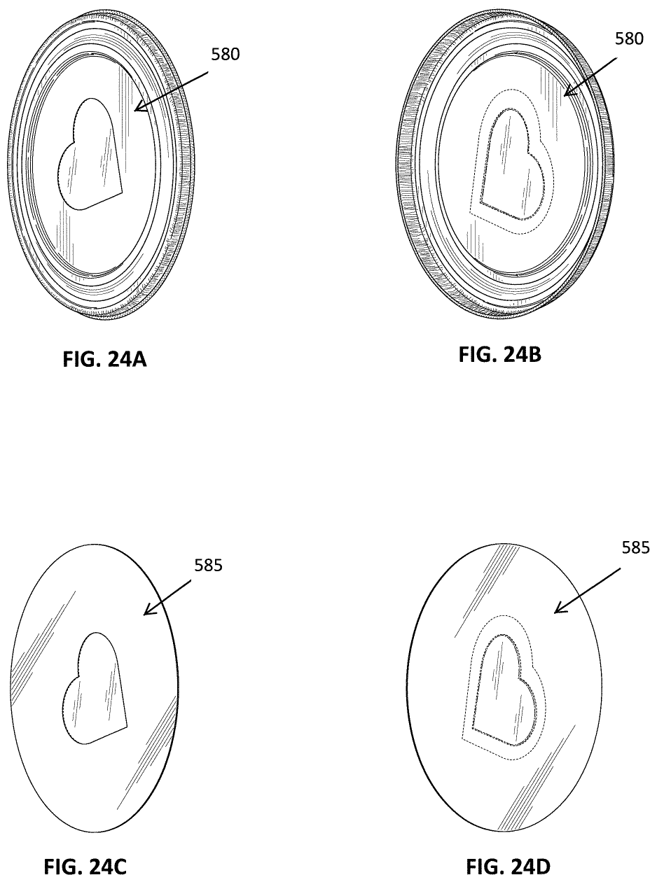

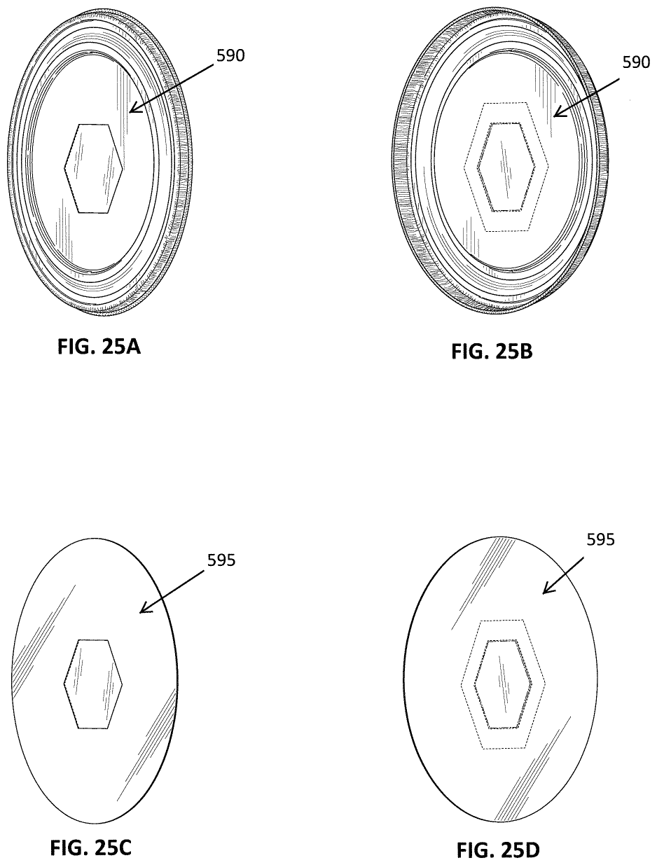

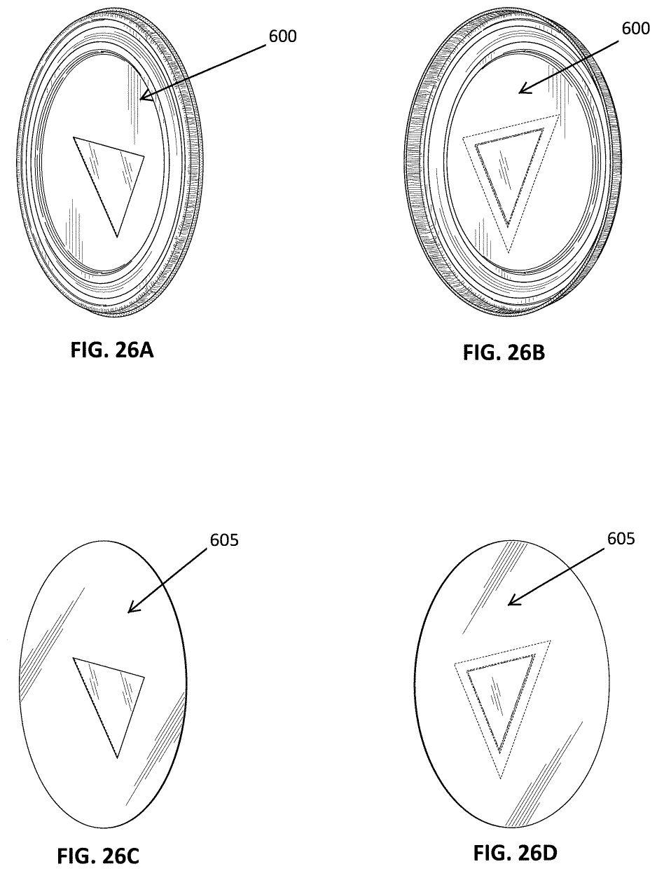

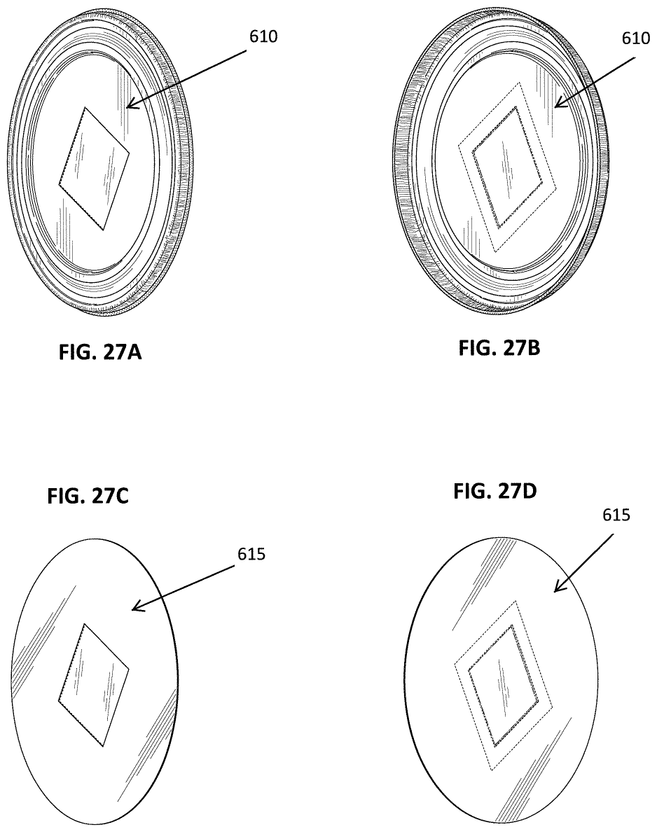

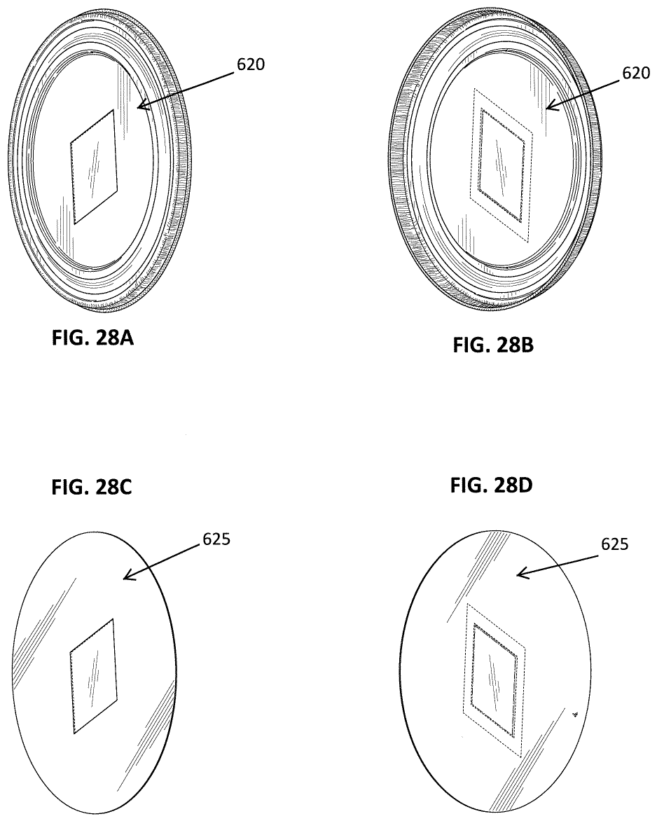

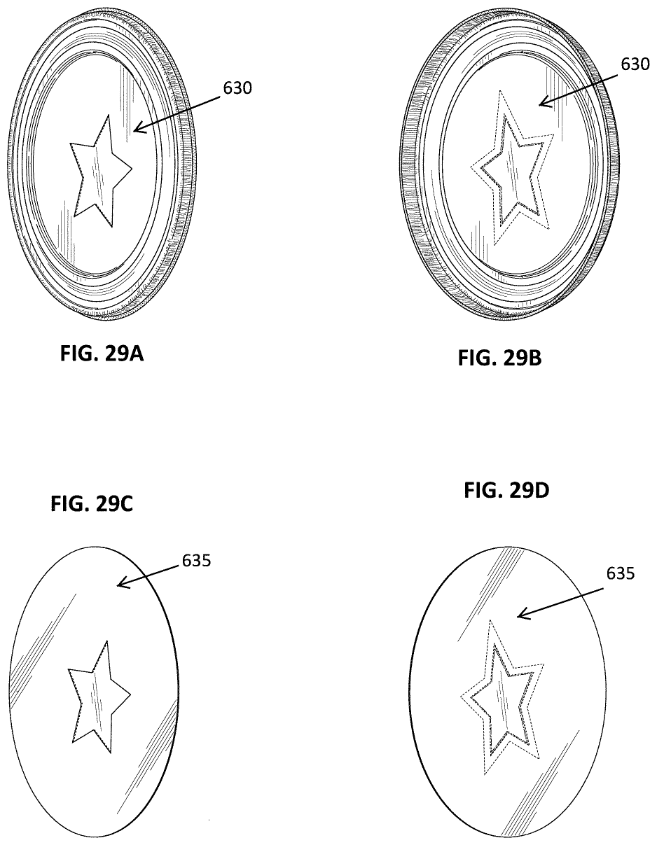

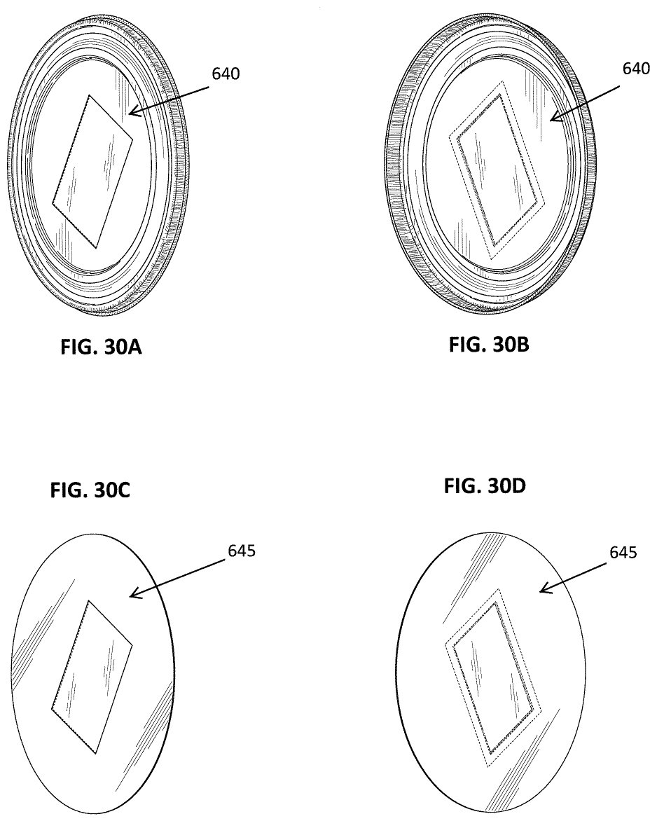

In various embodiments, the disposable aluminum lids and the disposable cardboard lids can have various shapes and include different shape windows. Referring now to FIG. 16A-30D, there is shown: (a) rectangular disposable lids with circular shaped windows 500 and 505 (FIGS. 16A-16D); (b) rectangular disposable lids with heart shaped windows 510 and 515 (FIGS. 17A-17D); (c) rectangular disposable lids with hexagonal shaped windows 520 and 525 (FIGS. 18A-18D); (d) rectangular disposable lids with triangular shaped windows 530 and 535 (FIGS. 19A-19D); (e) rectangular disposable lids with square shaped windows 540 and 545 (FIGS. 20A-20D); (f) rectangular disposable lids with diamond shaped windows 550 and 555 (FIGS. 21A-21D); (g) rectangular disposable lids with star shaped windows 560 and 565 (FIGS. 22A-22D); (h) circular disposable lids with circular shaped windows 570 and 575 (FIGS. 23A-23D); (i) circular disposable lids with heart shaped windows 580 and 585 (FIGS. 24A-24D); (j) circular disposable lids with hexagonal shaped windows 590 and 595 (FIGS. 25A-25D); (k) circular disposable lids with triangular shaped windows 600 and 605 (FIGS. 26A-26D); (l) circular disposable lids with square shaped windows 610 and 615 (FIGS. 27A-27D); (m) circular disposable lids with diamond shaped windows 620 and 625 (FIGS. 28A-28D); (n) circular disposable lids with star shaped windows 630 and 635 (FIGS. 29A-29D); and (o) circular disposable lids with rectangular shaped windows 640 and 645 (FIGS. 30A-30D).

In a second embodiment there is provided a disposable aluminum lid. The lid is stamped from aluminum. The lid is configured to include a base terminating around a periphery at an edge and the base has a top section and bottom section. A continuous skirt wall extends downwardly from the edge of the base to form a well around the bottom section. The continuous skirt being configured to bend. A window is formed through the base and further formed within the periphery of the base. A transparent material is secured over the window on the bottom section of the base.

In a third embodiment there is provided a method of manufacturing a disposable aluminum lid comprising the steps of: (a) placing a sheet of aluminum between a pair of die shoes; (b) stamping the pair of die shoes together to form, from the sheet of an aluminum, a disposable aluminum lid, and wherein the disposable aluminum lid is defined to include a base with a top section and a bottom section, the base terminating around a periphery at an edge and a skirt downwardly extending from the edge of the base; (c) cutting a window through the disposable aluminum lid; and (d) securing a transparent material over the window on the bottom section of the lid.

In a fourth embodiment of the invention, there is provided a disposable cardboard lid for a disposable pan. The lid includes a base having a cardboard material side and an aluminum material side secured to each other. The base has an outside terminal edge. A window is formed through the base. A transparent material is secured to one side of either the carboard material side or aluminum material side.

In a fifth embodiment of the invention, there is provided a method of forming a disposable cardboard lid for a disposable pan. The method includes the steps of (a) providing a cardboard material; (b) providing an aluminum material; (c) laminating the cardboard material to the aluminum material to form a base; (d) cutting the base to a predefined shape with an outside terminal edge; (e) cutting a window through the base; and (f) securing a transparent material to one side of either the cardboard material or the aluminum material.

In one or more of these embodiments, there may also be an adhesive secured around a boarder of the window on the bottom section to secure the transparent material to the bottom section. In addition, the window may have a profile shape from one of the following shapes: rectangle, square, circle, heart, hexagon, triangle, diamond, and star. And yet, in addition, the disposable aluminum lid has a defined shape of one of the following shapes, rectangle, square, circle, and oval.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A disposable aluminum lid comprising:
a lid stamped from a bendable formed aluminum, the lid being configured to include:
a base defining a top section and a bottom section, the base terminating at an outside edge;
a window formed through the base and being positioned within the outside edge of the base;
a skirt extending downwardly from an outside edge of the base and extending continuously around the base to form a well around the bottom section, the skirt further having a terminal lower edge; and
a transparent material secured over the window on the bottom section of the base.

2. The disposable aluminum lid of claim 1, further comprising an adhesive secured around a boarder of the window on the bottom section to secure the transparent material to the bottom section.

3. The disposable aluminum lid of claim 2, wherein the lid further includes a raised ridge extending around the periphery of the base between the top section and the skirt.

4. The disposable aluminum lid of claim 3, wherein the terminal lower edge of the skirt is has a formed rolled bead.

5. The disposable aluminum lid of claim 2, wherein the window has a profile shape from one of the following shapes: rectangle, square, circle, heart, hexagon, triangle, diamond, and star.

6. The disposable aluminum lid of claim 2, wherein the disposable aluminum lid has a defined shape of one of the following shapes, rectangle, square, circle, and oval.

7. A disposable aluminum lid comprising:
a lid stamped from aluminum, the lid being configured to include:
a base terminating around a periphery at an edge, the base having a top section and bottom section;
a continuous skirt wall extending downwardly from the edge of the base to form a well around the bottom section, the continuous skirt being configured to bend;
a window formed through the base and further formed within the periphery of the base; and
a transparent material secured over the window on the bottom section of the base.

8. The disposable aluminum lid of claim 7, further comprising an adhesive secured around a boarder of the window on the bottom section to secure the transparent material to the bottom section.

9. The disposable aluminum lid of claim 8, wherein the window has a profile shape from one of the following shapes: rectangle, square, circle, heart, hexagon, triangle, diamond, and star.

10. The disposable aluminum lid of claim 9, wherein the disposable aluminum lid has a defined shape of one of the following shapes, rectangle, square, circle, and oval.

11. A method of manufacturing a disposable aluminum lid comprising the steps of:
placing a sheet of aluminum between a pair of die shoes;
stamping the pair of die shoes together to form, from the sheet of an aluminum, a disposable aluminum lid, and wherein the disposable aluminum lid is defined to include a base with a top section and a bottom section, the base terminating around a periphery at an edge and a skirt downwardly extending from the edge of the base;
cutting a window through the disposable aluminum lid; and
securing a transparent material over the window on the bottom section of the lid.

12. The method of claim 11, wherein the step of securing the transparent material over the window on the bottom section of the lid includes the step of adding an adhesive around a boarder of the window on the bottom section to secure the transparent material to the bottom section.

13. The method of claim 12, wherein the step of cutting a window includes defining a shape of the window to one of the following profiles: rectangle, square, circle, heart, hexagon, triangle, diamond, and star.

14. The method of claim 13, wherein the step of stamping the disposable aluminum lid includes the step of forming the shape of the disposable aluminum lid from one of the following shapes, rectangle, square, circle, and oval.

15. A disposable cardboard lid for a disposable pan, the lid comprising:
a base having a cardboard material side and an aluminum material side secured to each other, the base having an outside terminal edge;
a window formed through the base;
a transparent material secured to one side of either the carboard material side or aluminum material side.

16. The disposable cardboard lid of claim 15 further comprising an adhesive secured around a boarder of the window on one side of either the carboard material side or aluminum material side, and the adhesive being configured to secure an outer edge of the window to said side.

17. The disposable cardboard lid of claim 16, wherein the transparent material is secured to the aluminum material side.

18. The disposable cardboard lid of claim 16, wherein the window has a profile shape from one of the following shapes: rectangle, square, circle, heart, hexagon, triangle, diamond, and star.

19. The disposable cardboard lid of claim 18, wherein the disposable cardboard lid has a defined shape of one of the following shapes, rectangle, square, circle, and oval.

20. A method of forming a disposable cardboard lid for a disposable pan, comprising:
providing a cardboard material;
providing an aluminum material;
laminating the cardboard material to the aluminum material to form a base;
cutting the base to a predefined shape with an outside terminal edge;
cutting a window through the base; and
securing a transparent material to one side of either the cardboard material or the aluminum material.

21. The method of claim 20, further comprising applying an adhesive around a border of the window on one side of either the cardboard material side or the aluminum material side, and securing an outer edge of the transparent material to said adhesive.

22. The method of claim 21, wherein the transparent material is secured to the aluminum material side.

23. The method of claim 21, further comprising forming the window to have a profile shape selected from one of the following shapes: rectangle, square, circle, heart, hexagon, triangle, diamond, and star.

24. The method of claim 23, further comprising forming the disposable cardboard lid into a defined shape selected from one of the following shapes: rectangle, square, circle, and oval.
